(19) United States
(12) Patent Application Publication
(10) Pub. No.: US 2004/0105459 A1
(43) Pub. Date: Jun. 3, 2004

(54) Method and a system to build efficient communications networks in which MPLS functionality is incorporated within the SONET/SDH/OTN transport equipment by performing it in the GFP layer

(76) Inventor: Raghu Mannam, Duluth, GA (US)

Correspondence Address: Raghu Mannam, 4933 Waterport Way, Duluth, GA, 30096, US

(21) Appl. No.: 10/370,247

(22) Filed: Feb. 20, 2003

Related U.S. Application Data
(60) Provisional application No. 60/429,875, filed on Nov. 30, 2002.

(51) Int. Cl. H04J 3/16

(52) U.S. Cl. 370/465; 370/352; 370/389; 370/401

(57) ABSTRACT

This invention creates a method and a device to implement cheaper, faster and more efficient communications networks and Virtual Private Networks. This is achieved by placing MPLS and non MPLS frames into GFP frames and performing MPLS functions within the GFP layer and optionally integrating with SONET/SDH/OTN cross connection functions or with Wavelength division multiplexing to create the GFP MPLS device. This technique called GFP MPLS switching, switches the GFP MPLS frames as if they are MPLS frames at intermediate devices. The GFP MPLS switched circuits are optionally groomed and carried over virtually concatenated SONET/SDH/OTN circuits and multiplexed with other TDM traffic for transport over SONET/SDH/OTN or WDM.

Cross-Reference to Provisional application No. 60/429875 dated Nov. 30, 2002

This invention was not made by an agency of the United States Government or under a contract with an agency of the United States Government

### BACKGROUND OF THE INVENTION

This invention entails faster, cheaper and more efficient telecommunications networks by uniquely integrating MPLS switching, Generic Framing Procedure, SONET/SDH virtual concatenation and SONET/SDH/OTN cross connection into a single device.

Telecommunications networks consist of two basic entities. One is the physical transport layer and the other is the data switching layer. The physical layer is implemented by SONET/SDH optical transport networks and the data switching layer by Ethernet, IP, MPLS and ATM switches or routers. The packet switching network is overlaid on the optical transport network to create the complete telecommunications network.

Fiber optic networks based on SONET/SDH have been the primary technology for implementing telecommunications networks. SONET/SDH is a mature technology and has been in operation for over fifteen years. Service providers have gained a lot of expertise in SONET/SDH in terms of deploying and managing the networks.

With the advent of the Internet and the rapidly increased data traffic through the telecommunication networks, SONET/SDH networks faced some deficiencies. The Generic Framing Protocol (GFP), the Virtual Concatenation scheme and the Link Capacity Adjustment Scheme (LCAS) have been introduced by the ITU and ANSI to address some of these deficiencies.

T1X1.5/2000-024R5, Generic Framing Procedure (GFP) (available at http://www.ieee802.org/17/documents/presentations/may2001/gfp.pdf) Generic Framing Procedure (GFP) is an ANSI standard that defines a generic framing procedure to delineate octet-aligned, variable length payloads from higher level client signals for subsequent mapping into octet-synchronous payload envelopes such as SONET or SDH. It also defines the frame formats for protocol data units (PDUs) transferred between GFP initiation and termination points, as well as the mapping procedure for the client signals into GFP. GFP supports many types of packets, including IP packets, HDLC frames and Ethernet frames. GFP maps layer two and layer three client signals into SONET/SDH payload and contains an optional extension header for carrying technology specific virtual link information. The GFP standard does not define mapping for MPLS frames based on the MPLS shim header. The invention achieves this purpose and also the integration between the MPLS switching with the SONET/SDH/OTN switching and integration between MPLS switching and DWDM by carrying the MPLS shim headers in the optional extension header.

ANSI T1.105 and ITU-T Rec. G.7041 created the virtual concatenation standard to help SONET/SDH networks to overcome their rigid data rate hierarchy by allowing creation of flexible rate channels for efficiently carrying Ethernet and other storage protocols. Virtual Concatenation is a method of creating a payload made up of two or more associated synchronous payload envelopes which are independently transported through a network. These channels are treated as one unit for administrative purposes.

The IU-T Draft Recommendation G.7042 “Link Capacity Adjustment Scheme (LCAS) for Virtual Concatenated signals” is a standard that allows the data rate of the channel to be modified while traffic is being carried on the channel. This feature helps to dynamically adjust the bandwidth of any circuit in a hitless manner.

The current state of the art in the physical layer (SONET/SDH) is the standard SONET/SDH plus the additional features provided by GFP, Virtual concatenation and LCAS. SONET/SDH enhanced by the features of GFP, Virtual concatenation and LCAS is called Data Over SONET (DOS) or Next Generation SONET/SDH. DOS provides framing for any type of data packets, flexible bandwidth assignment and dynamic bandwidth control. DOS is the state of the current art in optical transport networks.

Multiprotocol Label Switching Architecture IETF RFC 3031 January 2001 (available at http://www.ietf.org/rfc/rfc3031.txt) In the data switching domain, Multiprotocol Label Switching (MPLS), a public standard defined by IETF, uses the label swapping forwarding mechanism in which packets are appended a short label that tells the switching nodes along the path how to process and forward the data to the next hop. MPLS uses a stack of 32 bit shim headers to carry the label, the class of service and the time to live fields. MPLS uses standard label distribution protocols to set up label switched paths between ingress and egress MPLS nodes. This is the current state of the art in the packet switching layer.

In the prior art, the GFP frames are transported inside SONET/SDH circuits by SONET/SDH devices. The layer two and layer three switches extract the GFP frames from the SONET/SDH payload, the GFP overhead is processed and removed and the packet is switched in the layer two or layer three switch. The packet is again layer two or layer three framed and again GFP framed with GFP overhead and handed over to the SONET/SDH framer. The SONET framed packet is transported inside SONET/SDH circuits to its next packet switching hop by a SONET/SDH transport device. Thus the prior art uses a SONET/SDH transport device and a layer two or layer three packet switch to implement the communications network.

The invention converts MPLS frames and to GFP MPLS frames while preserving the MPLS information and switches the GFP MPLS frames as if they are MPLS frames. Other data packet formats also are converted to GFP MPLS frames by creating the MPLS header information inside the GFP frame so that all GFP MPLS frames can be switched as if they are MPLS frames.

An analogy between the airline network and the communications network is helpful in understanding the invention. In this analogy, the airline routes are compared to the SONET/SDH/OTN or WDM circuits and the passengers to data packets, the airline gates to SONET/SDH/OTN devices and the ticket counters to MPLS switches. With the prior art, MPLS frames are actually switched in MPLS switching devices in the layer 2 or layer 3 of the OSI model. Using the analogy this means that a passenger has to go to the ticket counter at every intermediate location to be again directed to the right aircraft to take. With prior art there are only two possibilities

1) Either the passenger has to take a direct flight between source and destination which is analogous to having a dedicated SONET/SDH circuit between the two edge switching routers or

2) Go to the ticket counter at every intermediate location to find out the next aircraft to take, enroute to the destination. This is analogous to being handed over to the data switching devices at every intermediate location for identifying the next hop.

Option 1 is expensive and wasteful because it is quite likely that all seats on the direct flights may not be fully sold. This is analogous to not having enough traffic to justify a dedicated SONET/SDH circuit. The problem with option 2 is that it is both expensive and slow. The passenger is slowed down because the passenger has to go to the ticket counter at all intermediate locations to be directed to the next flight segment to take, and also additional resources for operating that facility. This is the same as the data packet being slowed down and additional resources for the intermediate packet switches.

Figure One shows the current art implementation of a communications network in which the packet switching devices are connected to each other using SONET/SDH circuits provided by SONET/SDH transport devices. FIG. 2 shows how the optical line cards are duplicated in the SONET/SDH devices and core the packet switching devices. Both the routers and the SONET/SDH equipment require optical interface line cards resulting in duplication of these interfaces and additional expense and processing. It is an aim of the invention to prevent such duplication of optical line interface cards

FIG. 2 also shows the MPLS packet switching architecture in prior art where, GFP is used to frame layer 2 and layer 3 packets for efficiently transporting them over SONET/SDH circuits. Whenever the SONET/SDH path overhead is terminated, the GFP frame has to be terminated and the MPLS data packet given to the MPLS device for actual MPLS switching. This results in increased delays for the packet to reach its destination because of the need to remove GFP overhead, process layer 2 or layer 3 overhead and again add GFP overhead. It is an aim of the invention to switch data packets within the transport device and not need a separate layer 2 or layer 3 switching fabric/device to perform packet switching. FIG. 4 shows the integrated switching architecture of the invention.

FIG. 3 shows the need for many varieties of layer 2 and layer 3 packet switches in central offices or at intermediate locations of packet path. Because of the presence of many varieties of switching protocols, each type of packet has to be switched in the appropriate type of packet switch. Thus at a central office location, Ethernet frames will have to be given to an Ethernet switch for processing, Fiber Channel frames to a fiber channel switch and PPP frames to a POS client interface. Thus it is very expensive for network providers to buy these different kinds of client layer switches and maintain them. It is an aim of the invention to be able to switch many different layer two or layer three protocol packets by converting them to GFP MPLS frames, without requiring layer two or layer three switching fabrics in the equipment.

A virtual private network (VPN) is a network in which the routing and addressing plans remain private to the nodes on the network but uses common shared network facilities. The current common way of implementing VPNs is by using MPLS switches interconnected with SONET/SDH transport circuits. These VPNs are also called MPLS BGP VPNs or layer three VPNs. Similarly in the current art there are also implementations of layer 2 VPNs based on ATM switches or even Ethernet switches. In the current art the communications network is built to support a particular VPN architecture so the same network nodes cannot support different types of VPNs. In the current art MPLS packet forwarding is based on layer two switching so packet forwarding is tied to the link layer. Hence the current art cannot simultaneously support multiple types of VPN using the same devices unless all the link layer switch fabrics are present in the device. It is an aim of the invention to support many different types of VPNs simultaneously using a network of the invented devices.

### BRIEF SUMMARY OF THE INVENTION

The method of integrating MPLS with SONET/SDH/OTN and DWDM communications, claimed by the invention, is based on the following novel steps. They are

1) Replace the functionality of the MPLS packet switches and the SONET/SDH/OTN transport devices by a single device called GFP MPLS transport node (GFP MPLS TN). This removes the optical line interface card duplication problem in prior art.

2) Move packet switching currently done in the core layer two and layer three packet switches into the GFP layer by performing GFP MPLS switching between GFP MPLS devices. This makes packet switching independent of the layer two and layer three protocols, eliminates the many varieties of intermediate layer two and layer three packet switches and provides faster packet switching.

3) Perform GFP MPLS switching by creating and carrying one or more MPLS shim headers varying in size from 20 bits-to-32 bits, inside the GFP optional extension header as shown in FIG. 7, FIG. 8 and FIG. 9

4) Exchange routing and MPLS label distribution information between GFP MPLS devices and other routers/switches connected to them so that the GFP MPLS knows where to forward the GFP MPLS frames.

5) Implement layer three VPNs by advertising only VPN specific routes between customer routers connected to the edge GFP MPLS device using BGP.

6) Implement integrated MPLS SONET/SDH/OTN networks by providing seamless connectivity between MPLS edge routers and GFP MPLS edge devices. Achieve this by implementing standard MPLS label distribution protocols in the GFP MPLS devices and by carrying an MPLS label switched path between two MPLS label edge routers over a GFP MPLS circuit.

7) Transport GFP MPLS circuits over standard or virtually concatenated SONET/SDH paths.

8) Transport TDM traffic and the data traffic by incorporating a SONET/SDH/OTN cross connect fabric in the device.

According to the current invention, by incorporating the MPLS shim headers into the GFP frame, it can be switched as if it is an MPLS frame. Thus MPLS switching has been moved from above the link layer to inside the GFP layer. This ensures that the packet does not have to leave the GFP layer every time the SONET/SDH path overhead is terminated but will be switched within the GFP layer based on the information in the MPLS shim headers carried in the GFP frame.

Figure four shows a simplified architecture of the invention. The invention creates a method of MPLS switching called GFP MPLS switching and integrates it with a SONET or SDH or OTN cross connect switch to create the invented device. The GFP MPLS device provides both MPLS switching and optical transport functionality integrated in one box by inserting one or more MPLS shim headers in the GFP frame extension overhead bytes for switching and the SONET/SDH/OTN cross connect for transport. This solves the problem of requiring two boxes one for SONET transport and the other for packet switching and also eliminates the duplicate optical line cards needed for connecting the two pieces of equipment in prior art. With the invention, additional MPLS packet processing is eliminated at intermediate client nodes because the GFP MPLS frame itself is switched within the GFP layer rather than as a packet in the client layer, resulting in huge savings to the network provider. This is possible because the GFP MPLS transport node provides both SONET/SDH/OTN transport and at the same time MPLS switching.

Figure Five shows the invented network in which the core packet switching layer has been converged with the core SONET/SDH/OTN transport layer to create a simplified and single layer network of GFP MPLS switches. The customer routers can be customer IP routers or other core layer two or layer three switches such as ATM or Ethernet switches.

With the invention, a dedicated SONET/SDH path between two packet switching nodes is not required. This is because the present invention allows GFP MPLS circuits to be set up between the entry and the exit devices. This helps in more fully filling the existing SONET pipes because the GFP MPLS circuits will actually hop over multiple SONET/SDH paths rather than require a dedicated SONET path between two intermediate packet switching sites. Comparing with airline travel, the prior art forces an airline passenger to take a direct flight between two cities (assuming that the cities are two packet switching locations) whereas the invention allows an airline passenger to travel the same segment by taking multiple smaller segments. This helps in more fully populating the individual segments resulting in cheaper and more efficient communications network.

FIG. 7 shows how the invention creates MPLS paths for packet switching within the physical transport layer in the electrical domain. This is done, by carrying the one or more MPLS shim headers each varying in size from 20 bits to 32 bits in the GFP extension header. Prior art may carry labels for Ethernet or Packet over SONET but does not carry any MPLS header information.

The invention can set up MPLS circuits between any two customer routers to create a virtual private network (GFP MPLS VPN) for that customer. This is achieved by constrained distribution of routing information between edge GFP MPLS devices using the BGP community attribute. Many different types of VPNs may simultaneously be provided by a network of GFP MPLS devices. Because the physical transport layer is independent of the higher data and packet layer protocols, this technique allows creation of protocol independent virtual private networks. Thus the present invention supports any type of VPN by having in it a component to support the required routing protocol.

### BRIEF DESCRIPTION OF DRAWINGS

The invention can be better understood by referring to the drawings.

FIG. 1 shows the prior art core communications network in which the optical transport devices are connected in SONET rings and the packet switching devices are attached to the SONET devices. In the prior art packets are switched in the packet switching devices and are transported through SONET/SDH transport devices. Customer routers are connected to the packet switching devices. The packet switching devices implement virtual private networks.

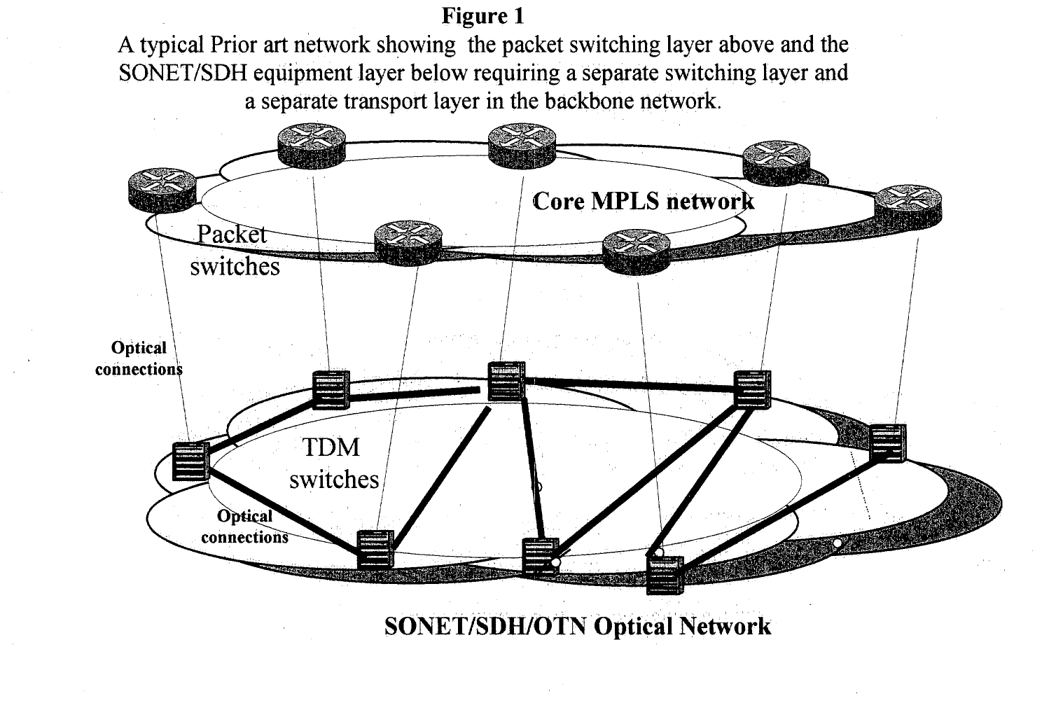

FIG. 2 shows how in the prior art, the optical line cards are needed to connect the SONET/SDH devices and the core IP/MPLS packet switching devices in a central office. This results in the need for four extra line cards just to connect the SONET/SDH devices with the packet switches. This is eliminated in the invention.

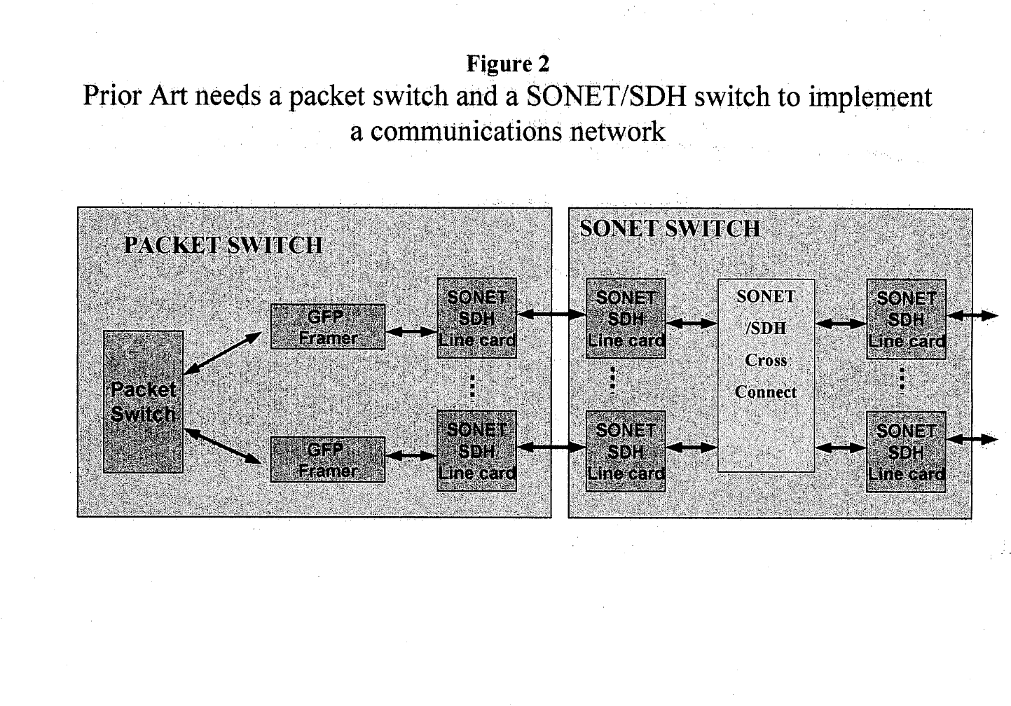

FIG. 3 shows prior art switching architecture in which the packet will have to be switched in its own type of switch. This requires the need for different types of switching equipment such as Fiber Channel switch, Ethernet switch, MPLS switch and ATM switch to actually do the switching. The SONET and GFP blocks perform SONET and GFP processing respectively.

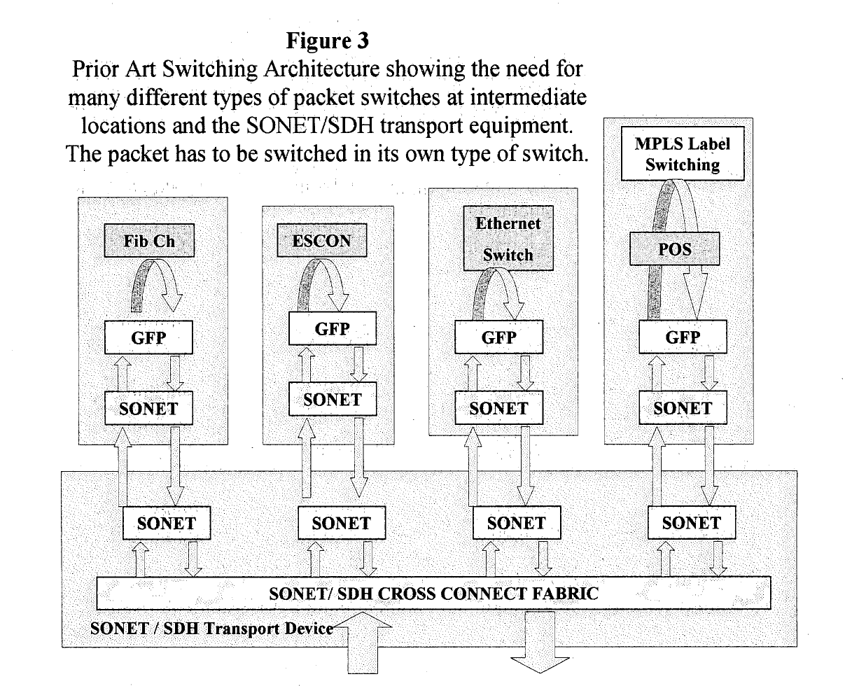

FIG. 4 shows the invention switching architecture in which a GFP MPLS switch is combined with a cross connect fabric. This eliminates two separate devices and also the optical line cards needed to connect the SONET/SDH devices with the packet switches. The TDM network traffic received by the device is cross connected in the SONET/SDH cross connect and the data traffic sent to the GFP packet switch as labeled GFP frames. The GFP frames are switched within the GFP layer and combined in a virtual concatenation unit and sent back on the line interface cards through the SONET/SDH cross connect.

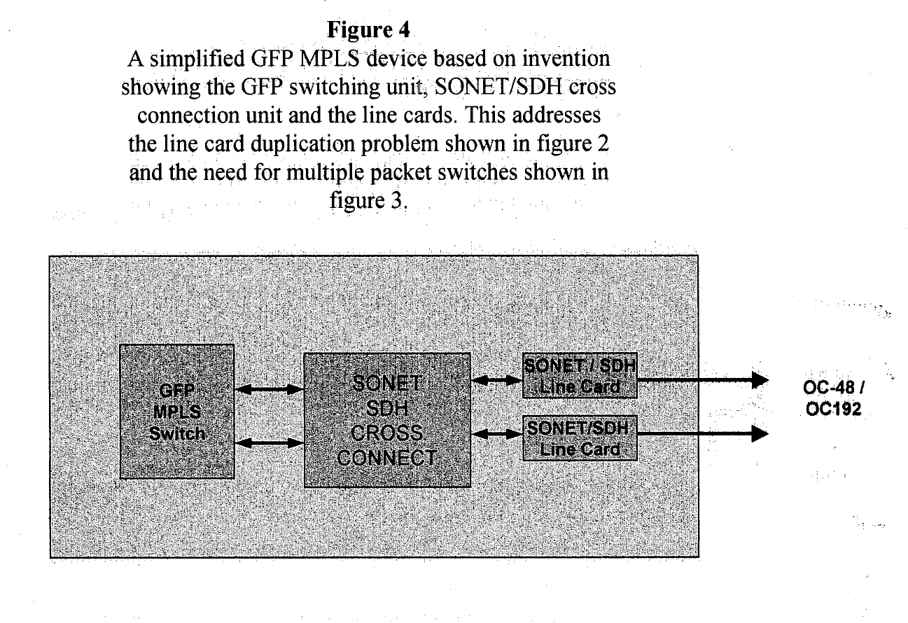

FIG. 5 shows the network as realized by the invention. The core packet switching functionality has been moved into the physical transport device resulting in a single box, eliminating expensive packet switching devices and optical interconnections between the packet switching and transport devices.

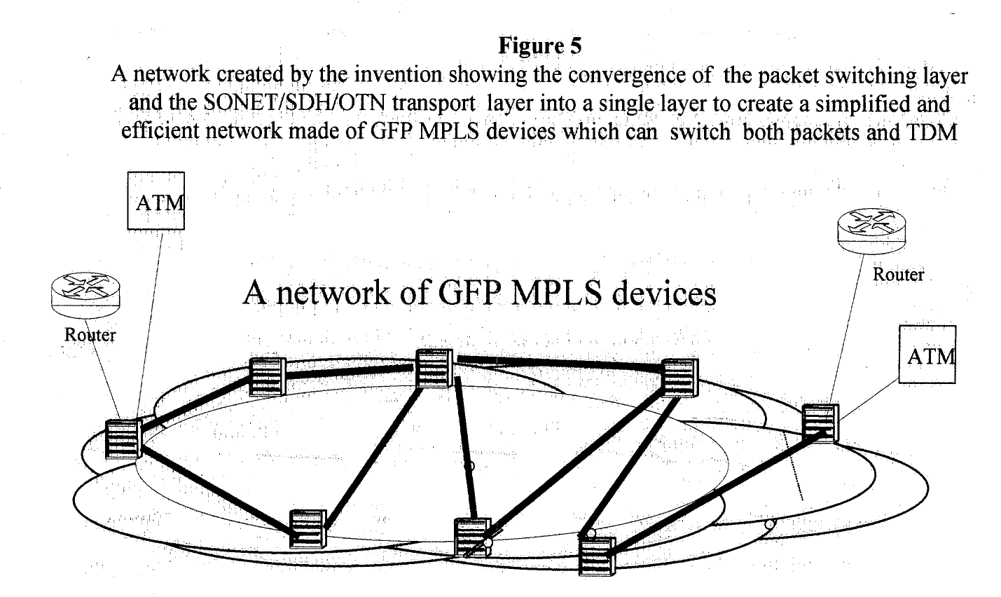

FIG. 6 shows the extension headers defined by the prior art called linear extension header and the ring extension header and the MPLS shim header structure that is used by the invention. The linear extension header is intended for scenarios where different independent links are aggregated into a single transport path and the different links are identified by the Channel ID field. This usage is unfit for MPLS switching purposes. The ring extension header is for sharing of the GFP payload with many clients in a ring configuration. The ring extension header also is unsuitable for MPLS packet switching. The prior art defined extension headers cannot perform MPLS switching of GFP frames whereas the invention brings this unique capability to switch GFP frames as if they are MPLS frames.

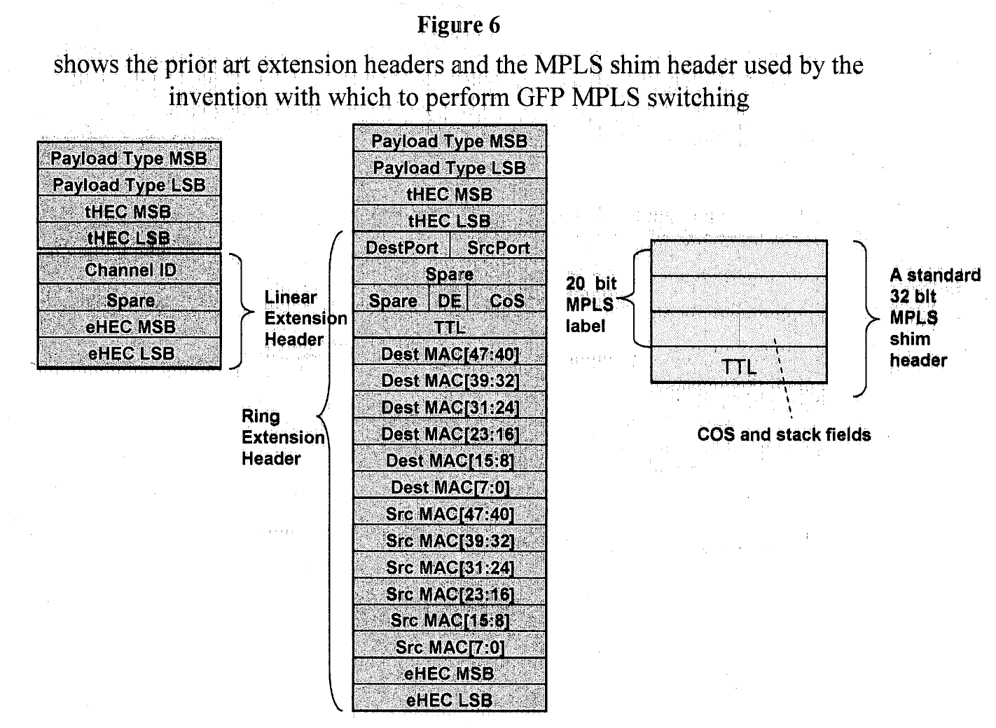

FIG. 7 shows how the MPLS shim header used to switch the packet is carried in the prior art and how it is carried in the invention. In the prior art, the IP packet and the MPLS label are encapsulated within the data link layer. Thus in order to switch the packet the link layer overhead has to be terminated at a link layer interface. In the invention one or more MPLS shim headers of varying size from 20 bits-to-32 bits is carried in the GFP payload header which is independent of link layer. This allows the packet to be switched without the need for layer 2 and layer 3 switches within the transport device itself.

FIG. 8 shows the details of the MPLS shim header and the details of the GFP framing. The data packet is encapsulated as shown in the picture as payload. The MPLS shim header will be placed in the optional extension header

FIG. 9 shows the prior art extension headers-the linear extension header and the ring extension header. The figure also shows how the invention uses the optional extension header. The invention header structure contains one or more MPLS shim headers each containing at least one 20 bit label field and optional 3 bit class of service field and an optional single bit stack field and an optional eight bit time to live field. The label field is used to switch the GFP frame and the class of service field is used to identify the priority of the GFP frame. The stack bit is used to indicate end of stack. The time to live field is used to keep a count of the number of MPLS switches before the GFP MPLS frame has to be discarded.

FIG. 10 shows the external interfaces and the basic operation of the invention. The system contains a set of aggregate interface cards (high speed cards), a set of tributary cards (low speed cards), a set of data interface cards, a SONET/SDH/OTN fabric, a virtual concatenation unit, a packet switch fabric, a forwarding unit and a routing unit. GFP MPLS frames are processed at the GFP processor, switched in the GFP MPLS switch fabric and sent to the cross connect for transport through standard multiplexing or virtual concatenation (VC) unit. The TDM circuits are cross connected in the SONET/SDH cross connect unit. The routing unit implements routing protocols and maintains the routing databases. The forwarding unit reads the routing databases and creates the forwarding databases. The forwarding unit also forwards the GFP MPLS frames.

FIG. 11 shows the details of the forwarding process. The packet forwarding unit receives the layer 2 and layer 3 packets from the data interface cards. For packets that need to be standard GFP processed, the data packet is GFP framed and sent to the virtual concatenation unit (VC) for transport. Layer 2 and layer 3 data packets that need to be GFP MPLS switched are handled by the GFP MPLS forwarding unit. It looks up the packet forwarding database and if a GFP MPLS virtual circuit is present for transporting that packet, the packet forwarding unit will identify the GFP MPLS virtual circuit to which the packet belongs and informs the GFP processor (payload dependent) values of the MPLS shim header structure to use. The GFP processor encapsulates the data packet and sends it to the packet switch. For GFP MPLS frames received from the VC unit, the GFP processor (payload independent) contacts the GFP MPLS forwarding unit for replacing the values in the MPLS shim structures and sends the modified GFP MPLS frame to the GFP MPLS switch for switching and transport.

FIG. 12 shows the control software architecture of the invention. The figure shows the routing units, the control units and the forwarding units. By separating the routing and forwarding unit, and by processing MPLS header in the GFP overhead the invention can forward any type of packet by having the appropriate routing unit installed in the device. The routing units exchange routing messages with their peers and build the routing databases. The packet forwarding table builder builds the packet forwarding database from the routing databases. The GFP MPLS Manager builds the GFP MPLS circuit database containing the GFP MPLS circuits from the connection signaling information received from the MPLS/GMPLS standard label distribution protocol units. The SONET Path Manager builds the SONET path database using the information in the SONET Topology Database. The SONET Topology database is built from the extended Link State Advertisements received from the other GFP MPLS devices and other transport nodes.

FIG. 13 shows a sample configuration of the invention. These include the optical line interface cards, the SONET/SDH cross connect units, the GFP MPLS switching units, the routing and control unit, the management unit, clock and other general functional units.

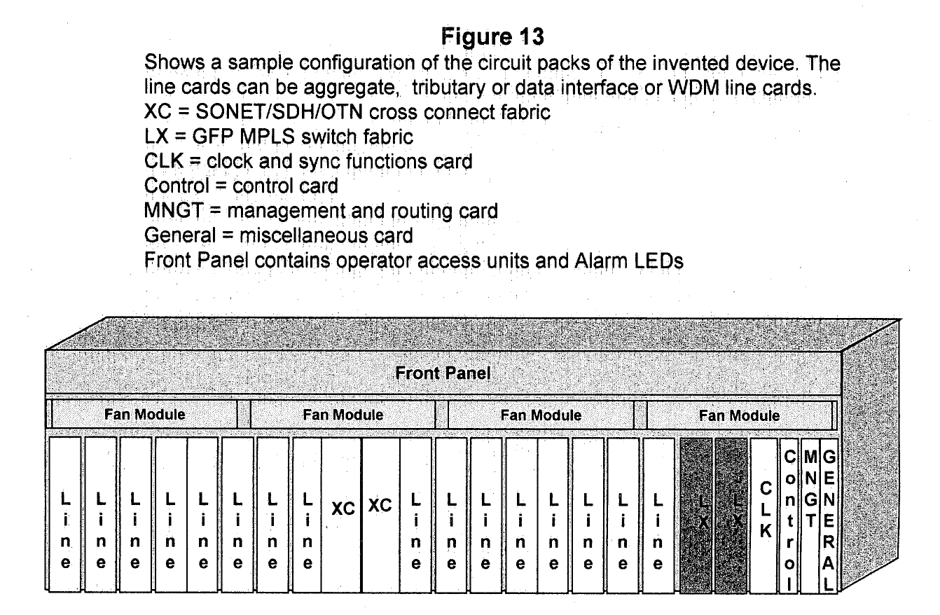

### DETAILED DESCRPTION OF THE INVENTION

The GFP LSR transport node will transport SONET/SDH TDM circuits using the SONET/SDH cross connect fabric and data circuits either through the standard GFP mode and or through the GFP MPLS mode.

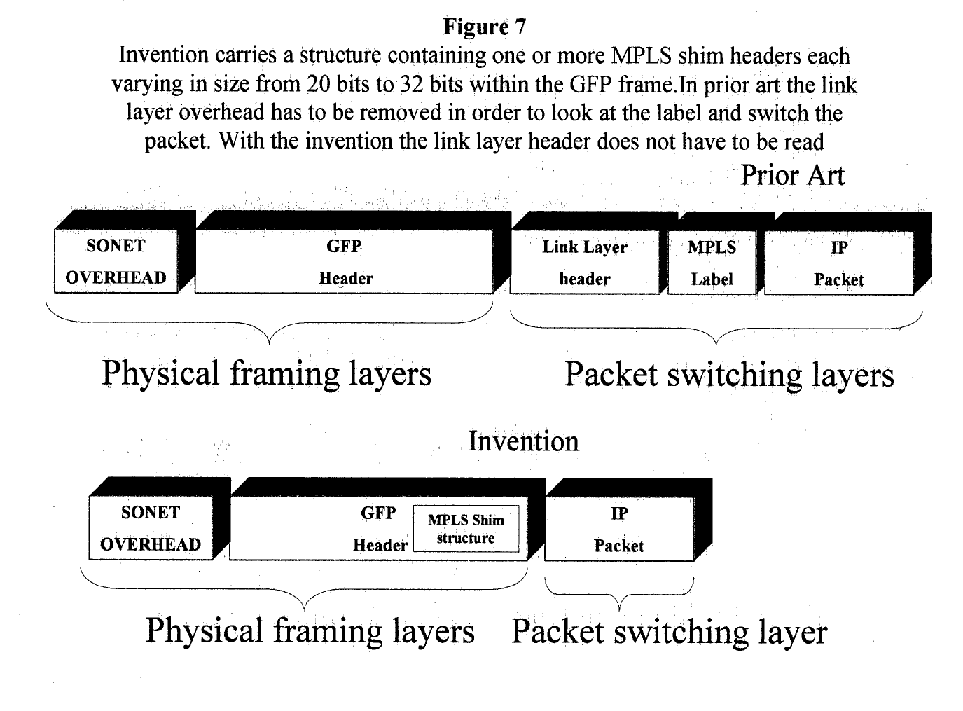

In order to perform packet forwarding at the GFP layer, the GFP layer must have a way to know where to forward the packet. This is achieved in the invention by carrying information pertaining to the destination of the packet in the optional GFP extension header. FIG. 7 shows how the invention carries one or more MPLS shim header structures inside the optional GFP extension header. FIG. 7 also shows how MPLS label switching is done in the previous art. By writing this MPLS shim header into the GFP framed packet, the link layer header does not have to be consulted during GFP forwarding at intermediate locations.

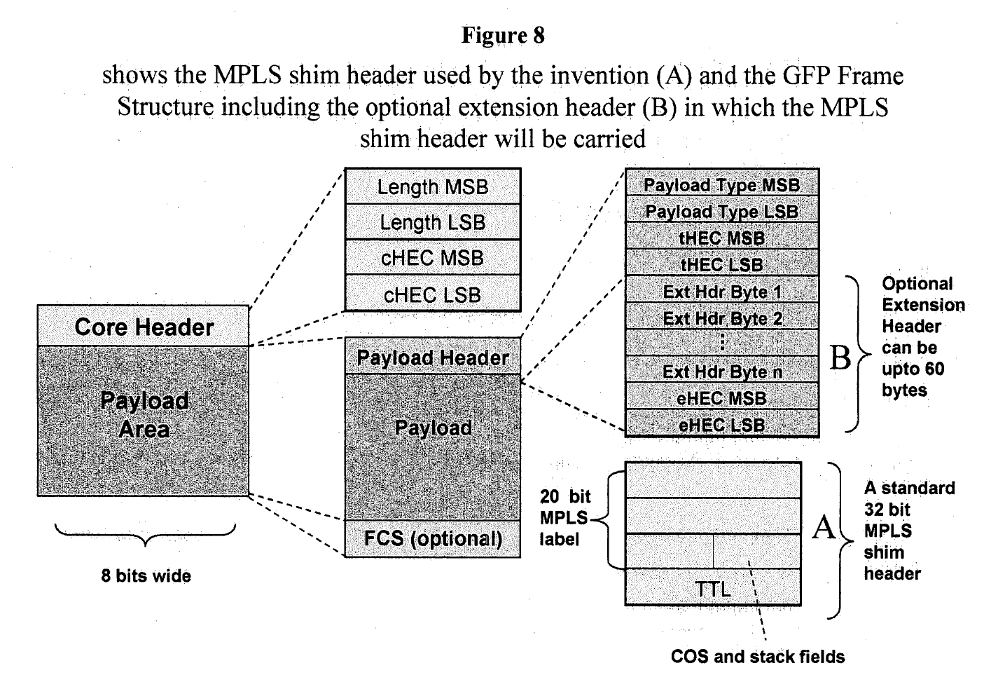

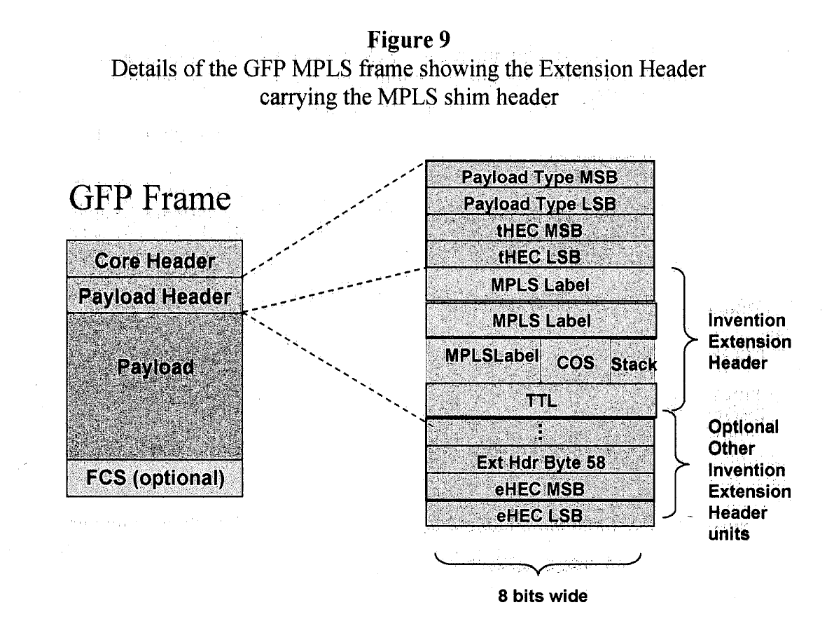

FIG. 8 and FIG. 9 show the details of the GFP framing bytes and the optional extension header fields. FIG. 8 shows the standard MPLS shim header and the standard GFP frame and FIG. 9 shows how the invention carries the MPLS shim header in the GFP optional extension header. The GFP standard mentions that the GFP extension header can have between 0-to-60 bytes containing technology specific headers such as virtual link identifiers, source destination addresses or port numbers. The GFP standard further defines two such technology specific extension headers called linear extension header and ring extension header and leaves other definitions to the equipment makers. The invention carries the MPLS shim headers in this field. This will help create a seamless network performing both MPLS switching and SONET/SDH/OTN and DWDM transport. The invention extension header carries one or more standard or truncated MPLS shim header structures. The standard MPLS shim header is 32 bits with a 20 bit MPLS label field, a three bit class of service, a one bit bottom of stack and an eight bit time to live field. A truncated MPLS shim header will contain the 20 bit label field and may or may not contain the class of service, stack and time to live fields. More than one standard or truncated MPLS shim header structures are needed in order to support multiplexing of GFP MPLS circuits within the GFP MPLS circuits. These fields are processed in the intermediate GFP MPLS devices using IETF MPLS standards

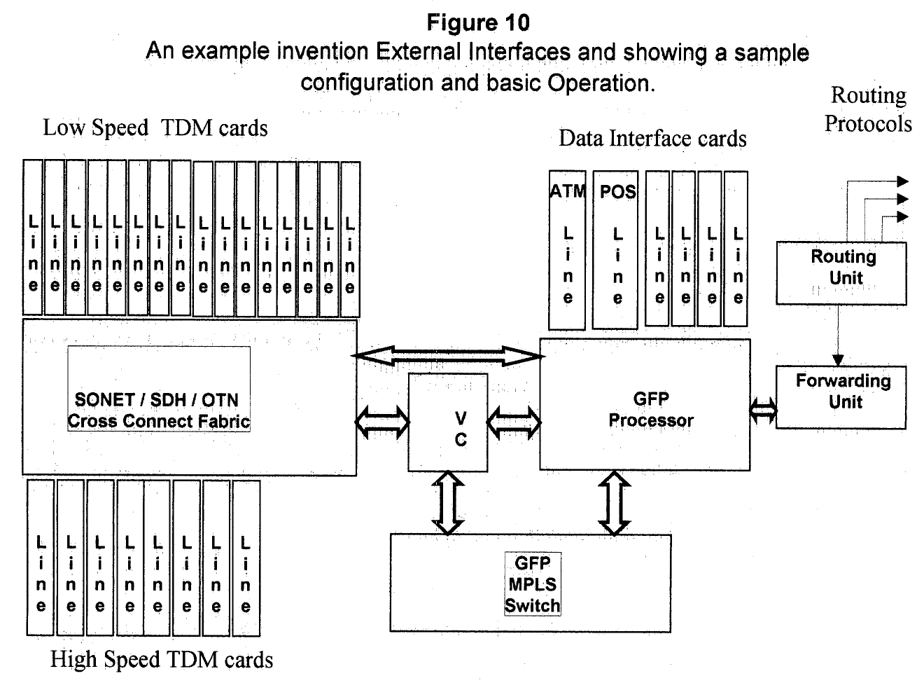

FIG. 10 shows the basic interfaces of the invention and is helpful in understanding the method and the device claimed by the invention.

The invention contains three types of interface cards the aggregate interface cards, the tributary interface cards and the data interface cards. The GFP processor receives packets from these interface cards. It receives GFP frames from the aggregate and tributary interface cards and data packets from the data interface cards and performs the following actions

1) The GFP processor implements the quality of service features and switches the GFP MPLS frames using standard MPLS processes mentioned in the IETF MPLS standards to direct the GFP MPLS frame to the correct line interface card based on the contents of the shim headers carried in the GFP extension header. The GFP processor after updating the MPLS GFP frame, sends it to the GFP switch to be forwarded to the next hop via the VC and the SONET/SDH unit.

2) For non MPLS data packets the system creates the MPLS shim header using IETF MPLS standards and inserts this shim header into the GFP extension header as shown in FIG. 9.

3) The virtual concatenation unit groups GFP MPLS circuits going to the same next hop into a virtual concatenated SONET/SDH path by using an existing SONET/SDH path or setting up a new virtually concatenated SONET/SDH path.

4) The VC unit then sends this virtual concatenated signal to the SONET/SDH cross connect fabric for transporting it on the appropriate line interfaces.

5) AT the exit GFP MPLS device, the GFP MPLS frame is converted back to the packet by removing the MPLS shim headers in the GFP extension headers and the packet handed over to the customer router through the data interfaces by the MPLS forwarding unit.

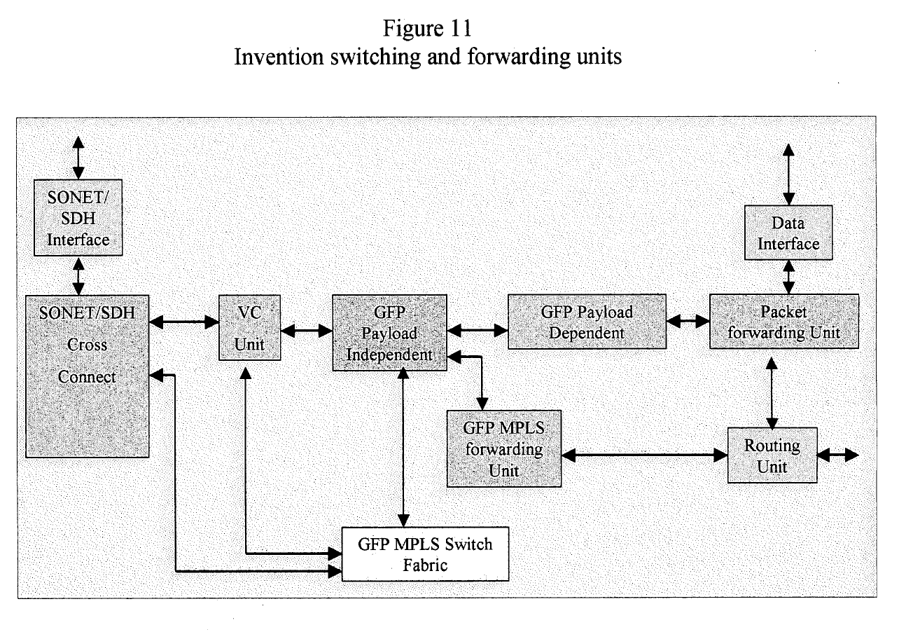

The device to implement the method consists of the following subsystem. FIG. 10 and FIG. 11 show how these units are connected with each other.

1) The High speed line interface cards (aggregate cards).

2) The Low speed line interface cards (tributary cards),

3) The Data interface cards (connected to customer routers)

4) The GFP processors

5) The optional SONET/SDH cross connect fabric

6) The GFP MPLS switch fabric

7) The Packet Forwarding Units to handle layer 2 and layer 3 packets

8) The MPLS Forwarding Units to handle GFP MPLS frames

9) The routing units

10) The control plane unit

11) The network management unit

12) The optional virtual concatenation unit

The High speed interface cards also called aggregate cards, connect to the high speed trunks towards the core of the network. The low speed interface cards also called the tributary cards connect to the subtending rings for collecting interoffice traffic and traffic from enterprise rings. All the SONET/SDH interface cards connect to the cross connect fabric. The STS/STM components of the TDM circuits are switched within the SONET/SDH cross connect fabric to the same or other high speed or low speed interface cards. These interface cards basically consist of optical transmitting and receiving units, the serializer/deserializer units, the clock and data recovery units and SONET/SDH framer, overhead processor and pointer processor units.

The GFP processor handles the following tasks.

1) Packets that are received from the High Speed or Low Speed SONET/SDH interface card ports, which need to be GFP terminated and handed over to a customer router.

2) Packets that are received from the High Speed or Low Speed interface card ports on SONET/SDH circuits terminated on the local node that need to be GFP MPLS switched and forwarded to their next hop

3) Packets that are received from the data interface cards that need to be standard GFP framed and sent to their TDM destination via the HS or LS cards, and

4) Packets received from the data interfaces of the device that need to be sent on GFP MPLS circuits

The GFP processor receives the data carrying SONET/SDH circuits from the aggregate and tributary interface cards through the SONET/SDH cross connect fabric. These are two types. The virtually concatenated circuits and the standard SONET/SDH circuits. The standard SONET/SDH data circuits are fed directly to the GFP processor after removal of the SONET overhead as GFP frames. The virtually concatenated data circuits are terminated in the virtual concatenation processor and are then fed to the GFP processor. Thus the GFP processor receives packets from the data circuits carried by the high speed and the low speed interface cards. The GFP processor also receives data packets from the data interface cards. These include the POS interface cards, the Ethernet and other data interface cards as shown in FIG. 11.

The Forwarding Unit consists of the Packet forwarding unit and the GFP MPLS Forwarding Unit. The Packet Forwarding unit consists of the packet forwarder and the packet forwarding database. The GFP MPLS Forwarding unit consists of the GFP MPLS Forwarder, and the GFP MPLS forwarding database.

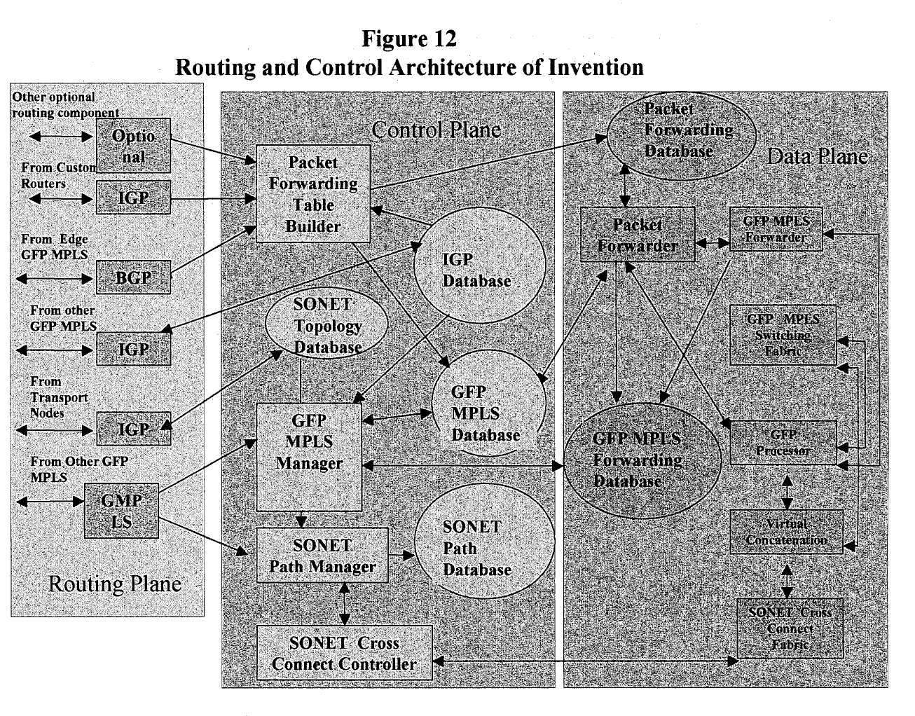

FIG. 11 and FIG. 12 are helpful in understanding the GFP MPLS Forwarding Unit. It handles GFP MPLS frames that are received from the payload independent portion of the GFP processor. These include those from the High Speed card ports and the Low Speed interface card ports that need to be GFP MPLS switched and forwarded to their next hop. The GFP processor processes the information in the extension header of the incoming GFP MPLS frame to the GFP MPLS Forwarding unit. The MPLS forwarding unit looks up the GFP MPLS forwarding database entry for this MPLS shim header and decides whether this packet needs to be forwarded or handed over to a client data interface card. IF the packet is to be forwarded to next hop, the GFP MPLS forwarder conveys the new MPLS shim header structure to the GFP processor. The GFP processor updates the extension header in the GFP MPLS frame and sends the updated GFP MPLS frame to the GFP switching fabric. The GFP switching fabric will switch this GFP MPLS frame based on the MPLS shim header structures to the next hop by sending the frame to the appropriate line interface card through the SONET/SDH cross connect via the virtual concatenation unit. The virtual concatenation unit groups all the GFP MPLS frames going to a particular next hop and transports them on a virtual concatenated SONET/SDH circuit.

FIG. 11 and FIG. 12 are helpful in understanding the Packet Forwarding Unit. It handles the layer 2 and layer 3 data packets that are received from the data interface cards that need to be GFP MPLS switched to the destination and the layer 2 and layer 3 packets that are sent by the GFP processor to be handed over to the layer 2 and layer 3 switches through the data interface cards.

The Packet Forwarding unit handles the data packets received by the GFP processor from the data interfaces of the device. It looks at the destination address of the packet and the interface on which it arrived and identifies the FEC and or the VPN to which the packet belongs. The Packet Forwarder then looks up the Packet Forwarding database to check if a GFP MPLS circuit already exists for that packet. If one exists, the Packet Forwarder informs the GFP processor the values to write in the extension header structure and forwards the GFP MPLS frame to the GFP MPLS switch fabric. In case the Packet forwarder after looking up the Packet forwarding database finds that there is no GFP MPLS circuit for that packet, the Packet Forwarder contacts the GFP MPLS Manager to set up a GFP MPLS path to the GFP MPLS device that is closest to the destination of the packet. The exit GFP MPLS device is identified based on the entries in the packet forwarding database for that packet and interface. The Packet Forwarding Database is constructed by the Packet Forwarding Table Builder. When the Packet Forwarder receives notification from the GFP MPLS Manager that a new GFP MPLS circuit has been created for that VPN, the Packet Forwarder looks up the GFP MPLS Database and updates the Packet Forwarding Database with the extension header information to use for outgoing packets for that FEC. The Packet Forwarder informs the GFP processor about the values to write inside the GFP optional extension header. The GFP processor then forwards the GFP MPLS frame to the GFP switching fabric for switching and transporting the it to its destination through the virtual concatenation unit and the SONET/SDH cross connect switch.

A GFP MPLS device may be used as an edge device or as a core device. When used as an edge device the GFP MPLS device interfaces with customer routers and acts like an edge MPLS device, converting customer packets to GFP MPLS frames and vice versa. When used as a core device the GFP MPLS does not have customer connections and performs GFP MPLS switching and SONET/SDH/OTN transport functions.

FIG. 12 shows the details of the routing unit, the control unit and the forwarding units.

The main functions of the routing component of the invention are

1) To gather and disseminate routing information received by the GFP MPLS devices from customer routers connected to them as well as from other GFP MPLS devices present in the network.

2) To ensure that secure VPNs can be set up by the constrained distribution of routing information.

3) If the customer routers are layer 3 switches, to selectively report only the customer routes to the other customer routers in the network.

4) If the customer routers are MPLS edge switches, to be able to take part in the label distribution signaling so that the GFP MPLS devices can appear just like an MPLS core switch for label forwarding and label distribution functions

5) To perform standard IETF MPLS label distribution functions for setting up/dismantling of GFP MPLS switched paths and also

6) To perform standard IETF GMPLS signaling and connection processing functions for setting up/dismantling SONET/SDH/OTN paths.

The routing unit implements the above functions by running multiple routing protocols and sending/receiving routing information

1) From customer routers that are directly connected to it through the data interface line cards using either RIP or OSPF or BGP or any other routing protocol.

2) From provider BGP routers and other GFP MPLS nodes, BGP routing information

3) From other GFP MPLS devices and provider intra domain routers, IGP routing information.

4) From provider transport nodes extended IGP routing information for topology discovery and automatic provisioning of SONET/SDH circuits and an

5) MPLS/GMPLS component to handle GFP MPLS label distribution functions and also to handle the connection processing functions for SONET/SDH path set up and provisioning.

6) Any other optional routing component to support that type of switching function

The invention uses the standard IGP routing protocol to gather and routing information between GFP MPLS devices. The information carried in the link state advertisements of OSPF or IS-IS protocols are extended by creating additional type, length, value objects so that additional attributes can be carried in the link state advertisements. The extensions include availability of bandwidth in the on that link, the features of the link, shared risk link group to which the link belongs and other attributes of the link. These advertisements are flooded throughout the domain to allow all the nodes in the domain to build a topology and extended link state database. These extended link state advertisements coming from transport nodes and GFP MPLS are collected in a database called the SONET/SDH topology database. The link state advertisements coming from the domain routers of the provider for the purposes of routing are collected in the IGP database as shown in the FIG. 12.

A layer three VPN is implemented by the invention by using BGP to selectively distribute the routing information received from customer routers to other customer as follows.

1) The edge GFP MPLS device receives routing information from customer routers that are connected to it.

2) This information is associated with a BGP community attribute and distributed via BGP to the other edge GFP MPLS devices. Thus the customer routing information is constrained by the VPN information of the customer by using BGP community attribute.

3) Other GFP MPLS devices receive this BGP information and forward only the routes belonging to that customer to the customer routers.

4) The packet forwarding table builder processes the received routing information from 1 & 2 and builds the packet forwarding database. The database contains different forwarding tables associated with different VPNs. This database is consulted by the packet forwarder for setting up GFP MPLS paths and also before forwarding a packet.

5) The GFP MPLS Manager sets up GFP MPLS circuits between edge GFP MPLS devices using the standard IETF MPLS label distribution protocols. The GFP MPLS Manager collects all the GFP MPLS circuits going through a GFP MPLS device into a database called the GFP MPLS database. The GFP MPLS circuits used by a particular VPN are filtered out and associated with the packet forwarding table to create the GFP MPLS forwarding table. The MPLS Forwarding Database contains a collection of MPLS Forwarding Tables.

6) A GFP VPN contains a collection of GFP MPLS circuits associated with that VPN. A GFP MPLS circuit may be transported over an end to end SONET/SDH circuit that may be shared by other GFP MPLS paths or may be transported by switching over individual shorter SONET/SDH segments. When they are transported over multiple SONET/SDH segments they are processed by the GFP MPLS logic in the GFP MPLS devices.

An MPLS network is implemented by the invention without the need for SONET/SDH transport devices or core MPLS switches as follows.

1) The entry edge GFP MPLS device connects directly to the entry MPLS edge label switching routers.

2) The entry edge GFP MPLS device receives/sends standard IETF label distribution signaling information and takes part in the signaling by using an RSVP or LDP together with their extensions. This information is propagated to other GFP MPLS devices and to the egress edge GFP MPLS TN device using the standard MPLS label distribution protocols.

3) The entry edge GFP MPLS TN device receives the MPLS label switched path connection request from the entry edge MPLS router. It internally converts this MPLS label switched path connection request into a request for the GFP MPLS path and propagates this information to the exit edge GFP MPLS device. The exit edge GFP MPLS device converts this information back into a regular MPLS label switched path connection request and sends it to the exit MPLS edge router using standard IETF MPLS label distribution protocols.

4) After the MPLS LSP has been established, the invention takes part in the MPLS packet forwarding as follows.

5) The edge GFP MPLS device writes the contents of MPLS shim header structure received in the layer two frame from the edge MPLS router into the GFP optional extension header as shown in FIG. 7 and FIG. 9.

6) Other core GFP MPLS devices receive this GFP MPLS frame and forward it using the GFP MPLS switching to the exit edge GFP MPLS devices.

7) The exit edge GFP MPLS device converts the GFP MPLS frame back into an MPLS frame together with the layer 2 overhead and the MPLS shim header.

The GFP MPLS paths and MPLS label switched paths are set up by the MPLS/GMPLS component and the GFP MPLS Manager using either RSVP or LDP or any other standard label distribution protocol. When the MPLS signaling component in the GFP MPLS device receives the request for a GFP MPLS circuit, this request is given to the GFP MPLS Manager. It creates the appropriate data structures for the newly created GFP MPLS circuit at the local node and checks to see if the GFP MPLS circiut can be transported over an existing one or more SONET/SDH path segments or virtually concatenated SONET/SDH path to the next hop GFP MPLS device. If an existing collection of SONET/SDH path segments allow such a carry of the requested GFP MPLS circuit, the request is granted otherwise a request is sent to the SONET/SDH Path Manager to set up a SONET/SDH path to the next hop GFP MPLS device.

SONET/SDH paths are managed by the SONET/SDH path Manager and the GMPLS signaling component. The SONET/SDH Path Manager receives the extended Link State advertisements from the transport nodes through the IGP protocol and constructs a SONET/SDH link state advertisement database. Requests for SONET/SDH path connections are received by the network management unit or by the GMPLS unit. The SONET Path Manager receives the requests either from the management unit or from the GMPLS unit for the SONET/SDH circuit creation/removal/modification. It uses the SONET/SDH Topology database to identify the best path and the available bandwidth and other resources. The SONET/SDH path manager then instructs the GMPLS unit to set up a SONET/SDH path with certain characteristics between the source and the destination transport nodes. As a consequence of this GMPLS signaling, all the cross connects along the path set up the appropriate cross connections by issuing the commands to the SONET/SDH cross connect controller to actually perform required sequence of actions to create an end to end SONET/SDH path. Virtually concatenated paths are also be set up by the same process. LCAS will be used to dynamically modify SONET/SDH virtually concatenated paths. The cross connect controller then sends the control signal to the SONET/SDH cross connect fabric for positioning the cross connection. Once the cross connection has been set up, the SONET Path Manager updates the SONET/SDH path database to include the newly created SONET/SDH path

It must be understood that the system, its subsystems and their interactions may be fine tuned or modified based on the actual requirements of the customer while the target of the object of the invention will be defined in the claims.

I claim

1) a method and a device to implement cheaper, faster and efficient communications networks and virtual private networks in which packet switching is incorporated within the SONET or SDH or OTN or WDM transport equipment by placing MPLS or non MPLS data frames into GFP frames to create GFP MPLS frames and performing MPLS switching of these frames, by a process called GFP MPLS switching to create GFP MPLS circuits and the device called GFP MPLS device.

2) Method according to claim 1 characterized in that the said GFP MPLS switching is optionally integrated with SONET/SDH/OTN switching.

3) Method according to claim 1 characterized in that said GFP MPLS circuits are transported over one or more SONET/SDH/OTN or WDM path segments between the entry and the exit GFP MPLS devices

4) Method according to claim 3 characterized in that, multiple GFP MPLS circuits passing through the same next hop are groomed and multiplexed for transport over a standard SONET/SDH/OTN circuit or optionally over a virtually concatenated SONET/SDH/OTN circuit.

5) Method according to claim 1, characterized in that said GFP MPLS frames are created by carrying one or more standard or truncated MPLS shim header structures each varying in size from 20 bits to 32 bits inside the GFP frame optional extension header and the data frame/data packet in the GFP payload area.

6) Method according to claim 5, characterized in that said MPLS shim header structure contains at least one 20 bit MPLS label field and optional 3 bit class of service field, optional single bit stack field and optional eight bit time to live field.

7) Method according to claim 1 characterized in that said GFP MPLS switching is achieved by performing standard MPLS switching operations (as mentioned in the IETF MPLS standards) for processing (reading/writing/replacing/creating and removing) the MPLS shim header structures contained in the GFP optional extension header to switch the GFP MPLS frames to the appropriate SONET/SDH/OTN or WDM line interface card.

8) Method according to claim 1 characterized in that virtual private networks (VPN) are implemented by exchanging VPN specific routing information between entry edge GFP MPLS device and exit edge GFP MPLS device to establish a GFP MPLS circuit and or by grouping specific GFP MPLS circuits to create a VPN.

9) Method according to claim 1 characterized in that standard MPLS switched circuits between two edge MPLS devices are carried over GFP MPLS circuits established in the transport layer itself.

10) System according to claim 1 comprising of the following units:
a) A routing unit capable of receiving and sending routing information between GFP MPLS devices for the establishment of GFP MPLS circuits and Virtual Private Networks.
b) A forwarding unit capable of identifying the GFP MPLS device closest to the destination of the packet and reading/writing/replacing/creating and removing the MPLS shim structures carried in the GFP extension header.
c) A GFP MPLS Manager to establish GFP MPLS circuits between two GFP MPLS devices.
d) A GFP processor to add/remove/process GFP framing.
e) A GFP MPLS switch, to switch between its different ports, GFP MPLS frames based on the information in the MPLS shim header structures contained in the GFP optional extension header.
f) An optional virtual concatenation unit to group said GFP MPLS paths into a SONET/SDH standard circuit or virtually concatenated circuit.
g) An optional SONET/SDH/OTN cross connect fabric for performing STS/STM/OTN and or VT1.5 TDM switching and
h) Aggregate SONET/SDH/OTN line cards containing framers/mappers/optics for transporting the TDM traffic on the high speed trunk side
i) Tributary SONET/SDH/OTN line cards containing framers/mappers/optics for transporting the TDM traffic on the tributary side
j) Data Interface line cards for receiving and sending packet data traffic from customer routers, MPLS switches and other layer two or layer three packet switches
